(19) United States
(12) Patent Application Publication
(10) Pub. No.: US 2008/0170883 A1
(43) Pub. Date: Jul. 17, 2008

(54) Image-Forming Device and Developing Method Thereof

(75) Inventors: Cheng-Chih Chen, Hsinchu (TW); Hui-Chun Lee, Hsinchu (TW); Yen-Liang Meng, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AETAS TECHNOLOGY, INCORPORATED, Irvine, CA (US)

(21) Appl. No.: 11/623,201

(22) Filed: Jan. 15, 2007

(51) Int. Cl. G03G 21/00; G03G 15/01

(52) U.S. Cl. 399/128; 399/223

(57) ABSTRACT

A developing method improves the printed image quality of an image-forming device by removing surplus charge potential to make the surface potential of a photoreceptor charged during first and second charging steps be the same for next developing, or by inputting different voltages to the developing units. An image-forming device is also disclosed.

### BACKGROUND

1. Field of Invention

The present invention relates to a developing method of an image-forming device. More particularly, the present invention relates to a developing method for improving the image quality of an image-forming device

2. Description of Related Art

Electrophotographic systems are generally employed in image-forming devices, the operation of which involves several steps: charging, exposing, developing, transferring, and fusing.

When the image-forming device prints an image, a high-voltage corona charging unit charges a surface of a photoreceptor to a charged potential of the photoreceptor. This is the charging step. However, several charging units must be utilized to complete the charging step for an image unit, such as a print-out, in a conventional one-pass type image-forming device, for example, U.S. Pat. No. 5,291,245, so the volume of the image-forming device becomes bigger, the production costs increase, and the amount of ozone generated during the charging process increases accordingly.

For example, U.S. Pat. Nos. 5,233,388 and 5,574,541 discloses a multi-pass type image-forming device (ex. four-pass), applied to improving the above defects, that has a single charging unit to complete the charging steps. Using the single charging unit to apply charging voltages on the photoreceptor for several times not only completes the charging steps, but also decreases the volume and the production costs of the image-forming device, and reduces the amount of ozone at the same time. However, this skill causes a problem that the charged potential of the photoreceptor are non-uniformly when the charge unit charges the photoreceptor for several times to form the image unit. FIG. 1 shows the potential difference on the surface of the photoreceptor between the first charging and the next chargings. Referring to FIG. 1, ΔV is the potential difference as the result of charging by multi-pass type image-forming device. Therefore, the potential on the photoreceptor cannot be maintained, so the printed image quality, after the developing of the image-forming device, cannot be maintained either.

Referring to U.S. Pat. No. 7,092,650, the solution is to dispose a sensor between the exposure element and the developing unit, so as to detect the potential on the photoreceptor. The detected signal is then transmitted to a control unit, so as to control the output voltage of the charging unit to maintain the potential on the photoreceptor. However, a high-precision sensor is necessary when adjusting the output voltage of the charging unit after detecting the potential on the photoreceptor. So, the production costs must accordingly increase.

For the foregoing reasons, there is a need to provide a method to solve the problem of non-uniform potential of the photoreceptor during the image-forming process.

### SUMMARY

It is therefore an aspect of the present invention to provide a developing method of image-on-image (IOI) forming process by removing surplus charge potential to maintain the printed image quality of the multi-pass type image-forming device after the developing step.

In accordance with one embodiment of the present invention, the method includes applying a charging voltage (first charging step) to an image-bearing member (ex: photoreceptor) by a charging unit so that the image-bearing member has a surface potential; exposing the photoreceptor having the surface potential by an exposure element to form a latent image on the photoreceptor; developing the latent image by a developing unit to form a toner image; removing surplus charging potential on the photoreceptor by an eraser after the charging unit re-applying a charging voltage (second charging step) to the photoreceptor with the toner image, wherein the surface potential of the photoreceptor charged during the first and second charging steps are the same for the next developing.

It is another aspect of the present invention to provide a developing method by using different voltages to develop and maintain the printed image quality of the image-forming device after the developing.

In accordance with another embodiment of the present invention, the method includes applying a charging voltage to an image-bearing member (ex: photoreceptor) by a charging unit so that the photoreceptor has a first surface potential; exposing the photoreceptor by an exposure element to form a first latent image on the photoreceptor; inputting a first voltage to a developing unit to develop the first latent image on the photoreceptor to form a first toner image; applying a charging voltage by the charging unit to the photoreceptor with the first toner image so that the photoreceptor has a second surface potential; exposing the photoreceptor by the exposure element to form a second latent image on the photoreceptor; inputting a second voltage different from the first voltage to the developing unit to develop the second latent image on the photoreceptor to form a second toner image.

It is yet another aspect of the present invention to provide an electrophotographic image system to maintain the printed image quality after the developing in the electrophotographic image system.

In accordance with yet another embodiment of the present invention, the electrophotographic image system includes a photoreceptor, a charging unit, at least one exposure element and developing units. The charging unit charges the photoreceptor so that the photoreceptor has a surface potential. The exposure element exposes the photoreceptor to form a latent image. The developing units apply toners to the latent image to form a toner image, and at least one of the developing units has the toners with different potentials by being inputted with different voltages.

In accordance with yet another embodiment of the present invention, the electrophotographic image system includes a photoreceptor, a charging unit, at least one exposure element, developing units and an eraser. The charging unit charges the photoreceptor so that the photoreceptor has a surface potential. The exposure element exposes the photoreceptor to form a latent image. The developing units apply toners to the latent image to form a toner image. The eraser removes surplus charges after the charging unit charges the photoreceptor with the toner image again to make the photoreceptor having the surface potential of a first charging.

### BRIEF DESCRIPTION OF THE DRAWINGS

The invention can be more fully understood by reading the following detailed description of the preferred embodiment, with reference made to the accompanying drawings as follows:

FIG. 1 shows the potential difference on the surface of the photoreceptor between the first charging and the next chargings; and

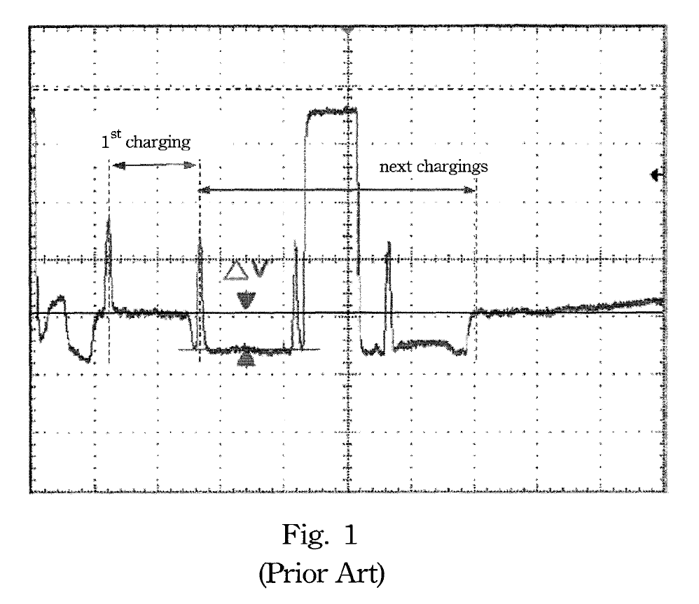

FIG. 2 shows an electrophotographic image-forming system according to one embodiment of the present invention; and

FIG. 3A shows an electrophotographic image-forming system according to another embodiment of the present invention; and

FIG. 3B shows an electrophotographic image-forming system according to yet another embodiment of the present invention; and

FIG. 4 shows the process of the developing method according to one embodiment of the present invention; and

FIG. 5 shows the process of the developing method according to another embodiment of the present invention; and

FIG. 6 shows the potential difference on the photoreceptor between the first charging and the next chargings according to one embodiment of the present invention.

### DESCRIPTION OF THE PREFERRED EMBODIMENTS

Detailed illustrative embodiments of the present invention are disclosed herein. However, specific details disclosed herein are merely representative for purposes of describing exemplary embodiments of the present invention. This invention may, however, be embodied in many alternate forms and should not be construed as limited to the embodiments set forth herein.

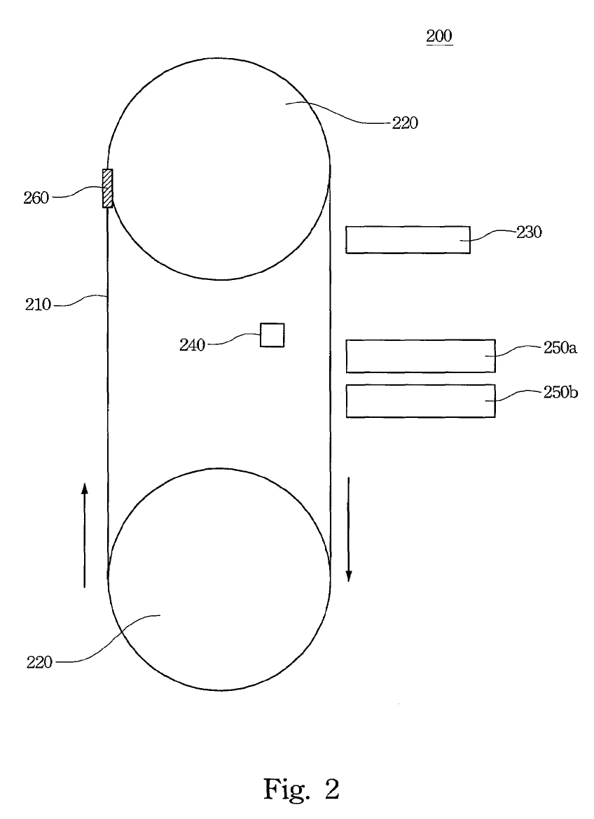

FIG. 2 shows an electrophotographic image-forming system according to one embodiment of the present invention. The electrophotographic image-forming system 200, using image-on-image (IOI) forming process, includes a photoreceptor 210, a transmission roller assembly 220, a charging unit 230, an exposure element 240 and two developing units 250a, 250b. The photoreceptor 210 is disposed on the transmission roller assembly 220 and rotates circularly with the transmission roller assembly 220 in the direction indicated by the arrow. The photoreceptor 210 can be a belt or a drum, and the charging unit 230 can be a corotron or a scorotron. Further, the exposure element 240 can be a laser or an LED device, and the number of developing units can be selected, such as four developing units or more, when necessary.

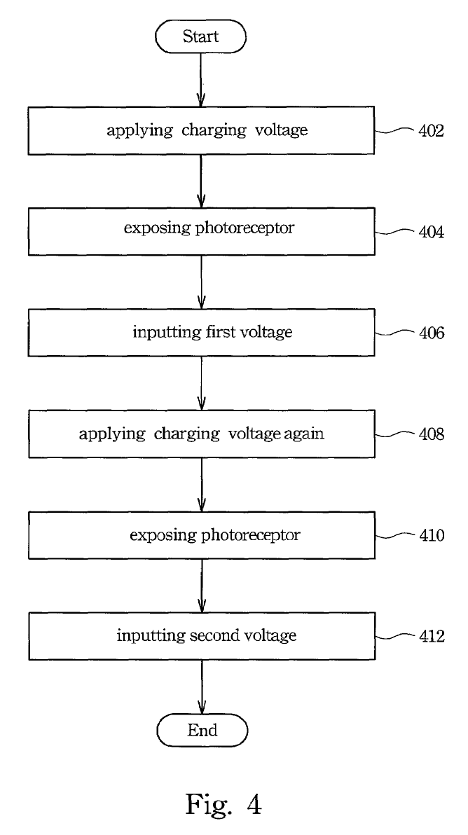

FIG. 4 shows the process of the developing method according to one embodiment of the present invention. Referring to FIG. 4 and FIG. 2, when the image-forming system prints an image, the charging unit 230 applies a charging voltage for the first time to the photoreceptor 210 so that the photoreceptor 210 has a first surface potential (step 402).

Then, the image to be printed is converted into an optical signal by the exposure element 240 (step 404) and irradiated on the photoreceptor 210 that is already charged with uniform charges to start the exposing step, so that the irradiated region has a higher potential than the un-irradiated region. Such a potential difference is used to represent the potential image, also called the latent image 260.

After the latent image 260 is formed on the photoreceptor 210, a first voltage is inputted into the developing unit 250a (step 406). Therefore, the electrostatic force makes the toners of the developing unit 250a adhere to the exposed region (latent image region) with a higher potential, so that the exposed region can attract the toners to form a toner image. The charging unit 230 then applies the charging voltage again (step 408) to the photoreceptor 210 that has the toner image thereon, so that the surface of the photoreceptor 210 has a second surface potential different from the first surface potential due to repeatedly charging. After that, the exposure element 240 exposes the photoreceptor 210 (step 410) again to form a second latent image on the photoreceptor 210. Therefore, a second voltage different from the first voltage is inputted into the developing unit 250b (step 412), so that the toners of the developing unit 250b have a different potential from the toner of the developing unit 250a. The exposed region therefore attracts the toners with the different potential corresponding to the second surface potential to form a second toner image and assures consistent printed image quality; that is, the output voltage of the developing unit 250b is adjusted with different voltages, so that the developing unit 250b has toners with different potentials.

In one embodiment, a first voltage with a lower value applies to the first developing unit during the first developing pass and a second voltage with a higher value applies to the second developing unit during the second developing pass. For example, the first voltage is −700V, and the second voltage is −800V. In another embodiment, when using the four-pass type image-forming system, the value of the second voltage, third voltage and fourth voltage is higher than the value of the first voltage. For example, if the first voltage is −700V during the first developing pass, the output voltage during the second, third and fourth developing pass is −800V. Further, the output voltage during the second, third or fourth developing pass can be different. An example is that the first voltage differs from the second, third and fourth voltage by more than 20V.

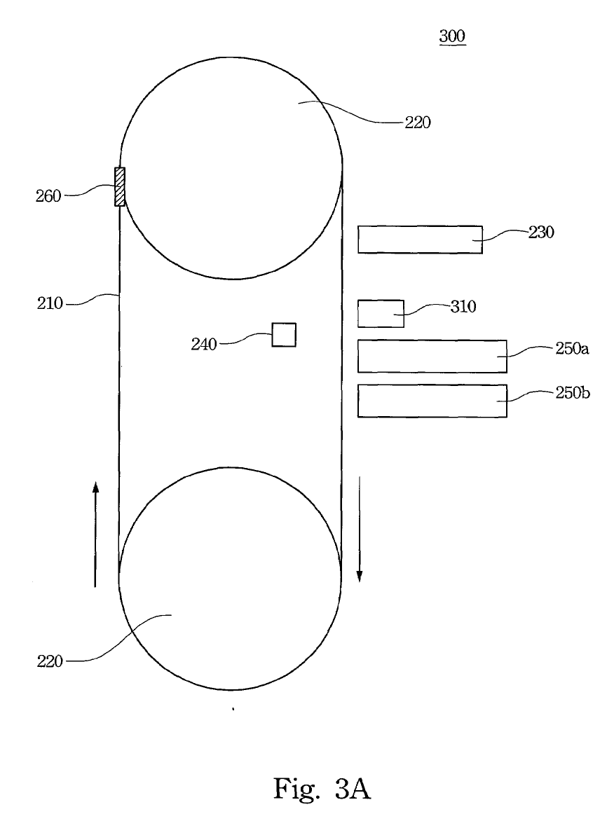

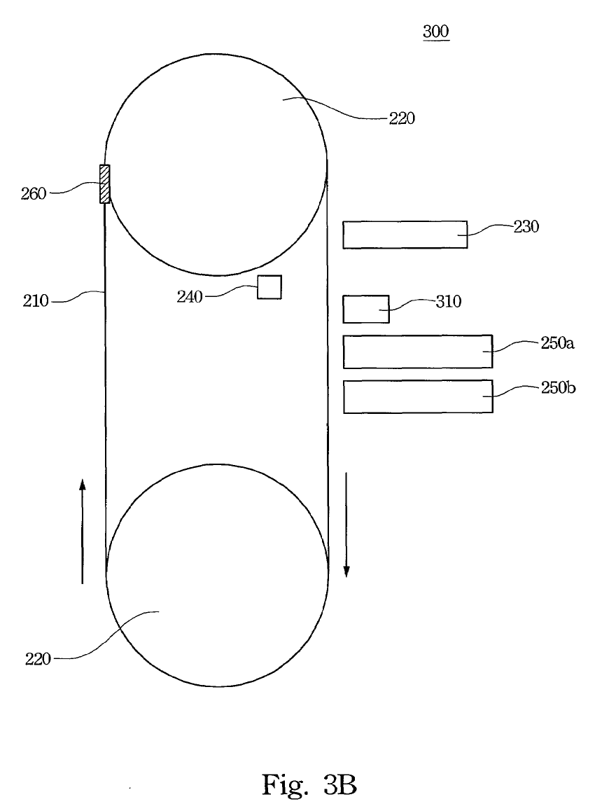

FIG. 3A shows an electrophotographic image-forming system according to another embodiment of the present invention. Comparing FIG. 3A with FIG. 2, an eraser 310 is added to remove surplus surface potential on the photoreceptor 210, and there is a gap between the photoreceptor 210 and the eraser 310.

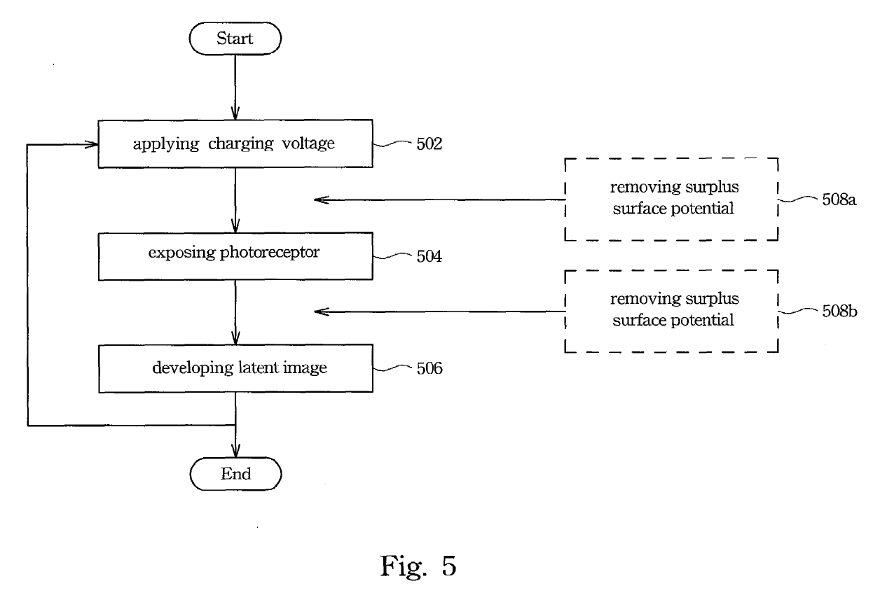

FIG. 5 shows the process of the developing method according to another embodiment of the present invention. Referring to FIG. 5 and FIG. 3A, when the image-forming system prints an image, the charging unit 230 applies a charging voltage on the photoreceptor 210 so that the photoreceptor 210 has a surface potential (step 502).

Then, the image to be printed is converted into an optical signal by the exposure element 240 (step 504) and irradiated on the photoreceptor 210 that is already charged with uniform charges to start the exposing step, so that the irradiated region has a higher potential than the un-irradiated region. Such a potential difference is therefore used to represent the latent image 260.

After the latent image 260 is formed on the photoreceptor 210, the toners of the developing unit 250a adhere to the exposed region due to the electrostatic force (step 506), so that the exposed region can attract the toners to form a toner image.

After the charging unit 230 applies the charging voltage (step 502) again on the photoreceptor 210 with the toner image, the eraser 310 removes the surplus surface potential (step 508a) to make the photoreceptor 210 have the same surface potential as the first charging surface potential for the next developing. The eraser 310 is operated before the exposure element 240; that is, to remove the surplus surface potential on the photoreceptor 210 (step 508a) before the exposure element 240 exposes the photoreceptor 210 again.

FIG. 3B shows an electrophotographic image-forming system according to yet another embodiment of the present invention. Referring to FIG. 3B and FIG. 5, the eraser 310 can also be operated after the exposure element 240; that is, to remove the surplus surface potential on the photoreceptor 210 (step 508b) after the exposure element 240 exposes the photoreceptor 210 again, so as to make the photoreceptor 210 have the same surface potential as the first charging surface potential.

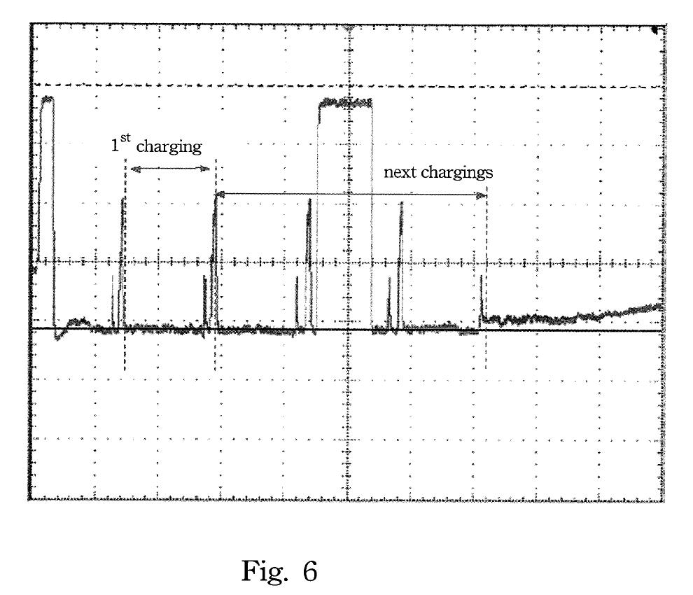

FIG. 6 shows a potential difference on the photoreceptor between the first charging and the next chargings according to one embodiment of the present invention. It is clearly found that the problem of the potential difference ΔV due to non-uniform charging voltages can be solved when using the method according to the embodiments of the present invention. Therefore, the printed image quality can be assured of consistency because the surface potential is maintained on the photoreceptor.

For the foregoing embodiments of the present invention, the developing method can be used to assure the consistency of the image quality.

Furthermore, a single charging unit is used for charging, so the volume and the production costs of the image system can be saved, and the amount of ozone can be reduced at the same time.

As is understood by a person skilled in the art, the foregoing preferred embodiments of the present invention are illustrated of the present invention rather than limiting of the present invention. It is intended to con various modifications and similar arrangements included within the spirit and scope of to the appended claims, the scope of which should be accorded the broadest interpretation so as to encompass all such modifications and similar structures.

What is claimed is:

1. A developing method of an image-forming device, comprising:
applying a charging voltage to a photoreceptor by a charging unit so that the photoreceptor has a surface potential;
exposing the photoreceptor having the surface potential by an exposure element to form a latent image on the photoreceptor;
developing the latent image by a developing unit to form a toner image; and
removing surplus charging potential on the photoreceptor by an eraser after the charging unit charging the photoreceptor with the toner image once again to make the photoreceptor have the same surface potential as the first charging surface potential for a next developing.

2. The developing method of claim 1, wherein the eraser removes the surplus surface potential on the photoreceptor before the exposure element exposes the photoreceptor once again.

3. The developing method of claim 1, wherein the eraser removes the surplus surface potential on the photoreceptor after the exposure element exposes the photoreceptor once again.

4. The developing method of claim 1, wherein the photoreceptor and the eraser have a gap therebetween.

5. The developing method of claim 1, wherein the photoreceptor is a belt disposed on a transmission roller assembly, and the belt rotates circularly with the transmission roller assembly.

6. A developing method of an image-forming device, comprising:
charging a surface of a photoreceptor by a charging unit so that the photoreceptor has a first surface potential;
exposing the photoreceptor by an exposure element to form a first latent image on the photoreceptor;
inputting a first voltage into a developing unit to develop the first latent image on the photoreceptor to form a first toner image;
charging the photoreceptor with the first toner image by the charging unit so that the photoreceptor has a second surface potential;
exposing the photoreceptor by the exposure element to form a second latent image on the photoreceptor; and
inputting a second voltage different from the first voltage into the developing unit to develop the second latent image on the photoreceptor to form a second toner image.

7. The developing method of claim 6, wherein the photoreceptor is a belt fixed on a transmission roller assembly, and the belt rotates circularly with the transmission roller assembly.

8. The developing method of claim 6, wherein the value of the second voltage is higher than the value of the first voltage.

9. The developing method of claim 6, wherein the difference of the values of the second voltage and the first voltage is higher than 20V.

10. An electrophotographic image-forming system, comprising:
a photoreceptor;
a charging unit for charging the photoreceptor so that the photoreceptor has a surface potential;
at least one exposure element for exposing the photoreceptor to form a latent image; and
a plurality of developing units for applying toners to the latent image to form a toner image;
wherein at least one of the developing units has the toners with different potentials by being inputted with different voltages.

11. The electrophotographic image-forming system of claim 10, wherein the developing unit is inputted with a first and a second voltage, wherein the value of the first voltage is smaller than the value of the second voltage.

12. The electrophotographic image-forming system of claim 10, wherein the value of the voltage inputted into the developing unit at the first time differs from the values of the voltages inputted later into the developing unit by more than 20V.

13. The electrophotographic image-forming system of claim 10, wherein the electrophotographic image-forming system is a multi-pass type image-forming system.

14. An electrophotographic image-forming system, comprising:
a photoreceptor;
a charging unit for charging the photoreceptor so that the photoreceptor has a surface potential;
at least one exposure element for exposing the photoreceptor to form a latent image;
a plurality of developing units for applying toners to the latent image to form a toner image; and
an eraser for removing surplus surface potential after the charging unit charging the photoreceptor with the toner image once again to make the photoreceptor have the same surface potential as a first charging surface potential.

15. The electrophotographic image-forming system of claim 14, wherein the eraser is operated before the exposure element exposes the photoreceptor once again.

16. The electrophotographic image-forming system of claim 14, wherein the eraser is operated after the exposure element exposes the photoreceptor once again.

17. The electrophotographic image-forming system of claim 14, wherein the electrophotographic image-forming system is a multi-pass type image-forming system.

18. The electrophotographic image-forming system of claim 14, wherein the photoreceptor is a belt fixed on a transmission roller assembly, and the belt rotates circularly with the transmission roller assembly.

19. The electrophotographic image-forming system of claim 14, wherein the photoreceptor is a drum.
